(19) United States
(12) Patent Application Publication
(10) Pub. No.: US 2024/0154399 A1
(43) Pub. Date: May 9, 2024

(54) HARDWARE FOR ENABLING INTERFACE WITH OPTICAL FIBERS IN AN OVERHEAD ELECTRICAL CABLE

(71) Applicant: CTC Global Corporation, Irvine, CA (US)

(72) Inventors: William Webb, Laguna Niguel, CA (US); Ian M. Pilling, Rancho Santa Margarita, CA (US); Christopher Wong, Santa Ana, CA (US); Douglas A. Pilling, Bonita, CA (US)

(21) Appl. No.: 18/548,632

(22) PCT Filed: Mar. 7, 2022
(86) PCT No.: PCT/US2022/019206

§ 371 Date: Sep. 1, 2023

Related U.S. Application Data
(60) Provisional application No. 63/157,603, filed on Mar. 5, 2021.

(51) Int. Cl. H02G 7/05; G02B 6/44; G02B 6/48; H01B 5/10

(52) U.S. Cl. CPC H02G 7/056; G02B 6/4477; G02B 6/486; H01B 5/108

(57) ABSTRACT

Hardware components for the termination and/or splicing of overhead electrical cables that have optical fibers associated with the cable. The hardware components enable access to the optical fibers for connecting to interrogation devices or for connecting to telecommunications equipment. The hardware components also enable the optical fibers to pass through terminations and splices without damaging the optical fibers.

### FIELD

This disclosure relates to the field of overhead electrical cables, and particularly to hardware components that are used to install and support overhead electrical cables for the transmission and/or distribution of electricity. This disclosure particularly relates to hardware components that enable the passage of optical fibers from the overhead electrical cable through the hardware for subsequent connection to interfacing equipment such as interrogation equipment or telecommunications equipment.

### DESCRIPTION OF THE DRAWINGS

FIG. 1 illustrates a portion of an overhead electrical transmission line.

FIG. 2 illustrates a cross-sectional view of an assembled termination apparatus according to the prior art.

FIG. 3 illustrates a perspective view of an assembled and crimped termination apparatus according to the prior art.

FIGS. 4A-4B illustrate overhead electrical cables including optical fibers coupled to a strength member.

FIG. 5 illustrates a termination apparatus according to an embodiment the present disclosure.

FIG. 6 illustrates a termination apparatus according to an embodiment of the present disclosure.

FIG. 7 illustrates a termination apparatus according to an embodiment of the present disclosure.

FIG. 8 illustrates a termination apparatus according to an embodiment of the present disclosure.

FIGS. 9A and 9B illustrate a termination apparatus according to an embodiment of the present disclosure.

FIGS. 10A to 10C illustrate a termination apparatus according to an embodiment of the present disclosure.

FIG. 11 illustrates a termination apparatus according to an embodiment of the present disclosure.

FIGS. 12A and 12B illustrate a gripping assembly according to an embodiment of the present disclosure.

FIGS. 13A to 13C illustrate a termination apparatus according to an embodiment of the present disclosure.

FIGS. 14A to 14C illustrate a spacer clip that is useful in a termination apparatus according to the present disclosure.

FIG. 15 illustrates the use of a spacer clip in a termination apparatus according to the present disclosure.

FIGS. 16A to 16B illustrate a termination apparatus according to an embodiment of the present disclosure.

FIGS. 17A and 17B illustrate a termination apparatus according to an embodiment of the present disclosure.

FIG. 18 illustrates an embodiment of a splice assembly according to the present disclosure.

FIG. 19 illustrates an exploded view of a slice assembly according to an embodiment.

FIGS. 20A and 20B illustrate an embodiment of a splice assembly according to the present disclosure.

FIGS. 21A and 21B illustrate an embodiment of a splice assembly that incorporates an optical fiber ring.

FIG. 22 illustrates an embodiment of a splice assembly according to the present disclosure.

FIGS. 23A to 23D illustrate a splice assembly incorporating a bobbin system and a method for constructing the splice assembly according to an embodiment of the present disclosure.

### DESCRIPTION

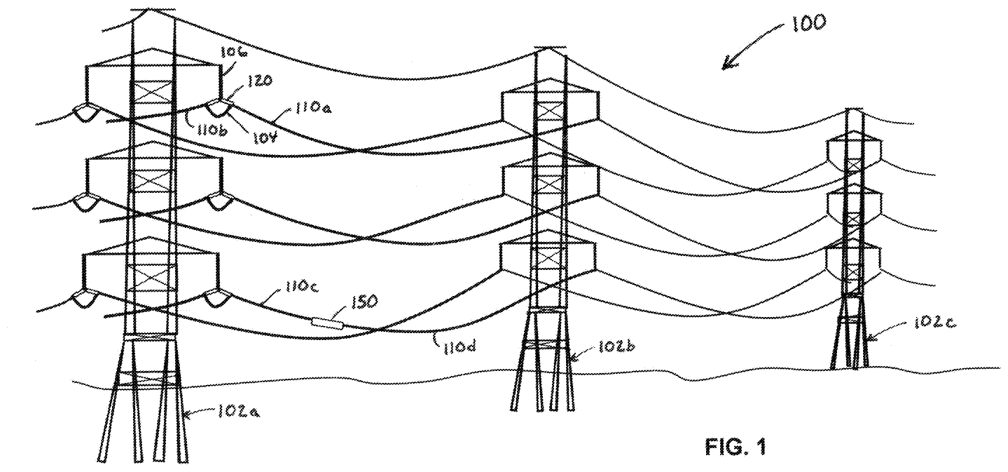

FIG. 1 illustrates a portion of an overhead electrical transmission line 100 for the transmission of electricity. Overhead electrical transmission and distribution lines are constructed by elevating electrical cables above the terrain using support towers (e.g., pylons) such as support towers 102a/102b/102c. The transmission and distribution lines may span many miles, requiring extremely long lengths of electrical cable, e.g., where many electrical cable segments are joined for electrical and mechanical continuity, and many support towers. Some of the support towers are referred to as dead-end towers or anchor towers, such as tower 102a. Such towers are located at termination points, e.g., power substations or locations where the electrical line is routed underground. Dead-end towers such as tower 102a may also be required where the electrical line changes direction (e.g., makes a turn), crosses a roadway or other structure where there is a high risk of damage or injury if the cable fails, or at regular intervals in a long, straight line path. In such instances, the overhead electrical cable must be terminated (e.g., severed), secured to the dead-end tower under high tension and electrically connected to an adjacent overhead electrical cable. As illustrated in FIG. 1, electrical cable segment 110a is secured (e.g., anchored) to tower 102a using a dead-end termination apparatus 120 (e.g., a tension clamp) and is electrically connected to an adjacent electrical cable segment 110b through an electrical jumper 104. The electrical cable segments 110a/110b are insulated from the support tower 102a by an insulator string 106.

Another termination structure is referred to as a splice. While the length of a single segment of overhead cable may cover several thousand feet, a power grid may require several hundred miles of electrical cable. To span these distances, the linemen must often splice (e.g., couple) two shorter cable segments together. Thus, one or more splices may be placed between two dead ends of an overhead cable installation. The splice functions as both a mechanical junction that holds the two ends of the cables together and an electrical junction allowing the electric current to flow through the splice. As illustrated in FIG. 1, a splice 150 operatively connects electrical cable segment 110c to electrical cable segment 110d to form a mechanical junction and a continuous electrical pathway.

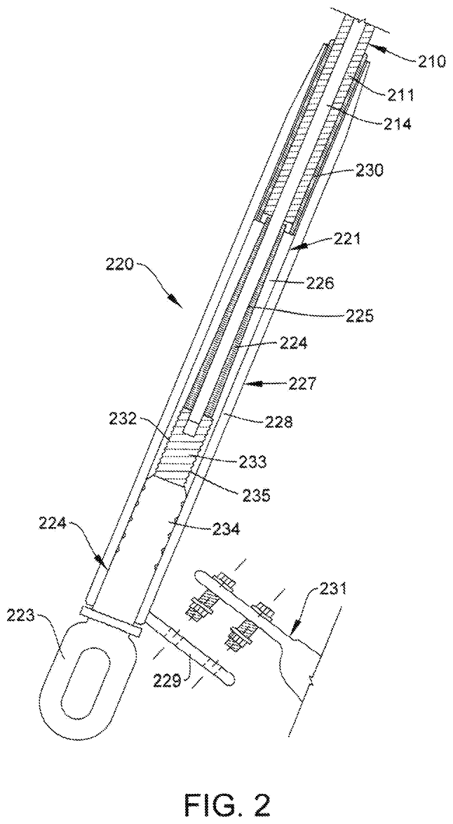

FIG. 2 illustrates a cross-section of an assembled termination apparatus (e.g., a dead-end) according to the prior art for use with a bare overhead electrical cable such as dead-end 120 in FIG. 1. The termination apparatus 220 illustrated in FIG. 2 is similar to that illustrated and described in PCT Publication No. WO 2005/041358 by Bryant and in U.S. Pat. No. 8,022,301 by Bryant et al., each of which is incorporated herein by reference in its entirety.

Broadly characterized, the termination apparatus 220 illustrated in FIG. 2 includes a gripping assembly 221 and a connector 222 for anchoring the termination apparatus 220 to a dead-end structure, e.g., to a tower as illustrated in FIG. 1 with a fastener 223 disposed at a proximal end of the termination apparatus 220. At the distal end of the termination apparatus 220, opposite the fastener 223, the termination apparatus 220 is operatively connected to an overhead electrical cable 210 that includes an electrical conductor 211 (e.g., comprising conductive strands) that surrounds and is supported by a strength member 214, e.g., a fiber-reinforced composite strength member.

The gripping assembly 221 tightly grips the strength member 214 to secure the overhead electrical cable 210 to the termination apparatus 220. As illustrated in FIG. 2, the gripping assembly 221 includes a compression-type fitting (e.g., a wedge-type fitting), specifically a collet 224 having a lumen 225 (e.g., a bore) that surrounds and grips onto the strength member 214. The collet 224 is disposed in a collet housing 226, and as the electrical cable 210 is tensioned (e.g., is pulled onto support towers), friction develops between the strength member 214 and the collet 224 as the collet 224 is pulled further into the collet housing 226. The conical (outer) shape of the collet 224 and the mating inner funnel shape of the collet housing 226 increase the compression on the strength member 214, ensuring that the strength member 214 does not slip out of the collet 224 and therefore that the overhead electrical cable 210 is secured to the termination apparatus 220.

As illustrated in FIG. 2, an outer sleeve 227 is disposed over the gripping assembly 221 and an end of the electrical cable 210. The outer sleeve 227 includes a conductive sleeve body 228 to facilitate electrical conduction between the electrical conductor 211 and a jumper plate 229. An inner sleeve 230 (e.g., a conductive inner sleeve) may be placed between the conductor 211 and the conductive body 228 to facilitate the electrical connection between the conductor 211 and the conductive body 228. The conductive body 228 may be fabricated from aluminum, and the jumper plate 229 may be welded onto the conductive body 228, for example. The jumper plate 229 is configured to attach to a connector plate 231 to facilitate electrical conduction between the electrical conductor 211 and another conductor, e.g., another electrical cable (not illustrated) that is in electrical communication with the connector plate 231.

The connector 224 includes a fastener 223 (e.g., an eyebolt) and gripping element mating threads 232 disposed at a gripping element end 233 of the connector body 234. The gripping element mating threads 232 are configured to operatively mate with connector mating threads 235 of the collet housing 226 to facilitate movement of the connector 224 against the collet 224, pushing the collet 224 into the collet housing 226, when the threads 235 and 232 are engaged and the connector 224 is rotated relative to the collet housing 226. This strengthens the compressive grip of the collet 224 onto the strength member 214, further securing the overhead electrical cable 210 to the termination apparatus 220. The fastener 223 is configured to be attached to a dead-end structure, e.g., to a dead-end tower, to secure the termination apparatus 220 and therefore the electrical cable 210, to the dead-end structure. See FIG. 1.

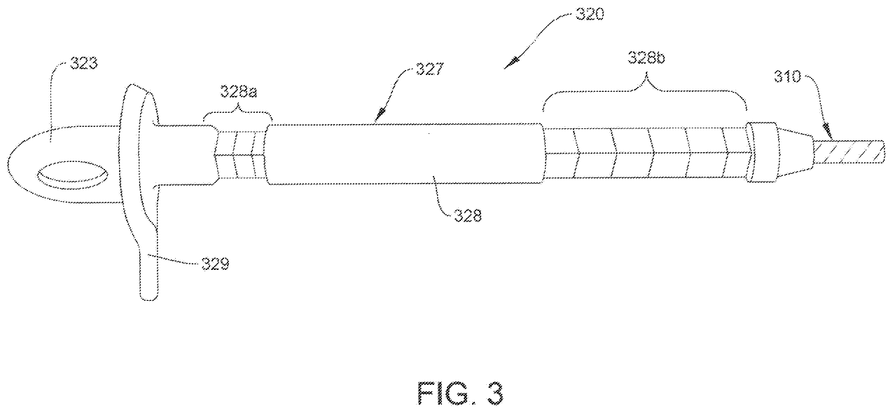

FIG. 3 illustrates a perspective view of a termination apparatus, similar to the termination apparatus of FIG. 2, that has been crimped (e.g., compressed) onto an overhead electrical cable. The termination apparatus 320 includes a connector having a fastener 323 that extends outwardly from a proximal end of an outer sleeve 327. A jumper plate 329 is integrally formed with the outer conductive sleeve body 328 for electrical connection to a connection plate (e.g., see FIG. 2). As illustrated in FIG. 3, the outer sleeve body 328 is crimped over (e.g., onto) two regions of the underlying structure, namely crimped sleeve body region 328a and crimped sleeve body region 328b. The crimped sleeve body region 328a is generally situated over an intermediate portion of the underlying connector (e.g., see FIG. 2), and the crimped sleeve region 328b is generally situated over a portion of the overhead electrical cable 310. The compressive forces placed onto the outer sleeve body 328 during the crimping operation are transferred to the underlying components, i.e., to the connector under the crimped region 328a and to portion of the overhead electrical cable 310 under the crimped region 328b to permanently secure the termination apparatus 320 to the electrical cable 310.

The termination apparatus broadly described with respect to FIGS. 2 and 3 can be utilized with various bare overhead electrical cable configurations. The termination apparatus illustrated in FIGS. 2 and 3 are particularly useful with overhead electrical cables having a fiber-reinforced composite strength member. For example, a compression wedge gripping element, e.g., having a collet disposed in a collet housing (e.g., FIG. 2), enables a fiber-reinforced composite strength member to be gripped under a high compressive force without significant risk of fracturing the composite material.

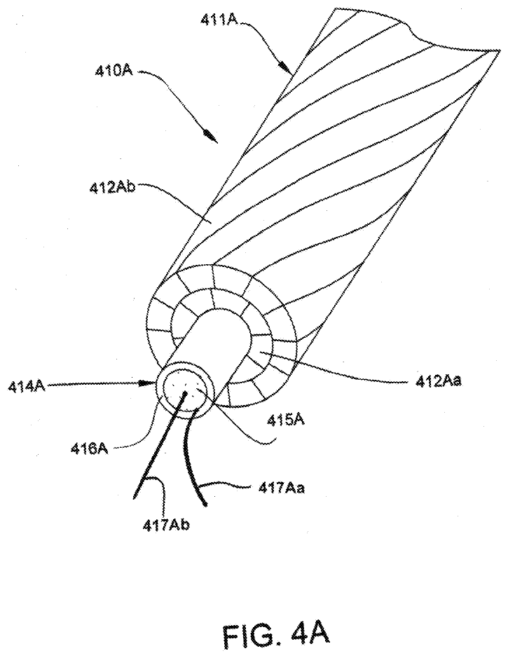

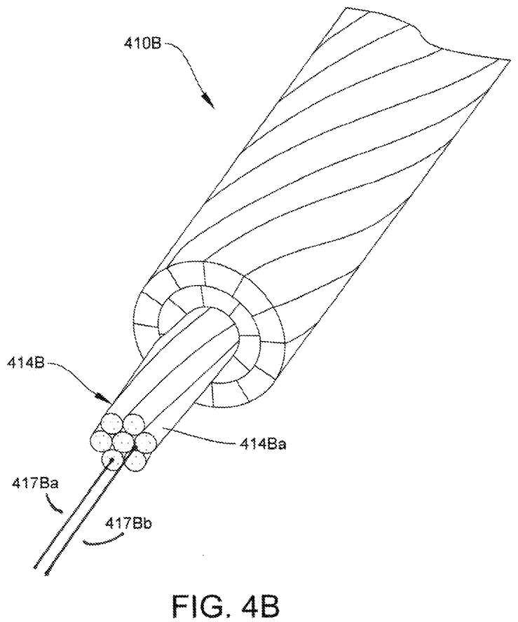

FIG. 4A illustrates an overhead electrical cable 410A that includes a strength member 414A fabricated from a fiber-reinforced composite material. The electrical cable 410A also includes a conductor 411A comprising a first layer 412Aa of conductive strands that are helically wrapped around (e.g., stranded around) the strength member 414A. A second layer 412Ab of conductive strands are wrapped around the first layer 412Aa. The conductive strands may be fabricated from conductive metals such as copper or aluminum, and for use in overhead electrical cables are typically fabricated from aluminum, i.e., pure aluminum or aluminum alloys. The conductive metals, e.g., aluminum, may not have sufficient mechanical properties (e.g., sufficient tensile strength) to be self-supporting without excessive sag when strung between support towers to form an overhead electrical line for transmission and/or distribution of electricity as illustrated in FIG. 1. Therefore, the strength member 414A physically supports or reinforces the electrical conductor 411A when the overhead electrical cable 410A is strung between support towers under high mechanical tension.

The strength member 414A illustrated in FIG. 4A is a fiber-reinforced composite strength member, e.g., comprising a plurality of reinforcing fibers disposed in a binding matrix. As illustrated in FIG. 4, the strength member includes a high strength section 415A (e.g., an inner section) comprising high strength and substantially continuous reinforcing fibers (e.g., carbon fibers) disposed in a polymer binding matrix (e.g., a thermoset or thermoplastic binding matrix). An insulative layer 416A (e.g., an outer layer) surrounds the inner section 415A to prevent galvanic corrosion that may result from intimate contact between the carbon fibers and the aluminum. For example, the insulative layer may be fabricated from an electrically insulative polymer such as a thermoplastic material. Alternatively, or in addition to a polymer layer, the insulative layer may include substantially continuous reinforcing glass fibers in a polymer binding matrix, for example. An overhead electrical cable of this configuration is available under the trademark ACCC® (CTC Global Corp., Irvine, CA), and is described in U.S. Pat. No. 7,368,162 by Hiel et al., which is incorporated herein by reference in its entirety. In addition, the strength member may include a layer of aluminum, e.g., disposed between the insulative layer 416A and the first conductive layer 412Aa. See, for example, U.S. Pat. No. 10,395,794 by Meyer et al. which is incorporated herein by reference in its entirety.

Such fiber-reinforced composite strength members may include a single fiber-reinforced composite strength element (e.g., a single rod) as is illustrated in FIG. 4A. Alternatively, the composite strength member may be comprised of a plurality of individual fiber-reinforced composite strength elements (e.g., individual rods) that are operatively combined (e.g., twisted or stranded together) to form the strength member as is illustrated in FIG. 4B. Examples of such multi-element composite strength members include, but are not limited to: the multi-element aluminum matrix composite strength member illustrated in U.S. Pat. No. 6,245,425 by McCullough et al.; the multi-element carbon fiber strength member illustrated in U.S. Pat. No. 6,015,953 by Tosaka et al.; and the multi-element strength member illustrated in U.S. Pat. No. 9,685,257 by Daniel et al. Each of these U.S. patents is incorporated herein by reference in its entirety. Other configurations and materials (e.g., other fibers and/or matrix materials) may be used for the fiber-reinforced composite strength member.

Referring back to FIG. 4A, the electrical cable 410A also includes at least one optical fiber that is associated with the electrical cable 410A. As illustrated, the cable 410A includes two (e.g., a plurality of) optical fibers, namely optical fibers 417Aa and 417Ab, that are embedded within the strength member 414A. More particularly, the optical fiber 417Aa may be characterized as being embedded within the high strength inner section 415A and the optical fiber 417Ab may be characterized as being embedded between the inner section 417A and the insulative layer 417A. It will be appreciated that such optical fibers may be associated with the electrical cable 410A by being placed in other positions, such as being disposed on the outer surface of the strength member 414A, e.g., between the strength member 414A and the first conductive layer 412Aa.

Referring to FIG. 4B, a similar overhead electrical cable 410B is illustrated. As noted above, the electrical cable 410B includes a strength member 414B having a plurality of strength elements (e.g., strength element 414Ba) that are combined (e.g., helically wrapped) to form the strength member 414B. In this case, one or more optical fibers, such as optical fiber 417Bb, are associated with the electrical cable 410B, e.g., disposed between individual strength elements in addition to or as an alternative to embedded optical fibers such as optical fiber 417Ba. As with the cable illustrated in FIG. 4A, optical fibers may be placed in other positions throughout the cross-section of the electrical cable 410B.

In any of the foregoing configurations, the optical fibers are typically disposed along the entire length of the electrical cable. The optical fibers may be disposed in a substantially linear fashion or may be non-linear, e.g., may be twisted or wrapped around the strength member. Such optical fibers may be utilized for communications (e.g., for data transfer) and/or may be utilized to interrogate (e.g., to inspect) the electrical cable to determine a condition of the electrical cable, i.e., as an interrogation element. For example, BOTDR (Brillouin optical time domain reflectometry) may be used to assess the temperature of the electrical cable and/or the stress state of the strength member along the length of the cable. One example of optical fibers being used in an overhead electrical cable for interrogation purposes is illustrated in International Patent Publication No. WO 2019/168998 by Dong et al., which is incorporated herein by reference in its entirety.

No matter the function of the optical fibers, it will be necessary to access at least one of the ends of the fibers, e.g., to reliably introduce light (e.g., coherent light from a laser) into the ends of the optical fibers, and to detect and/or analyze light emanating from the same or an opposite end of the optical fibers. However, as can be seen in FIGS. 2 and 3, when the overhead electrical cable is terminated at a dead end, (e.g., using a termination apparatus described above, the end of the strength member, and therefore the ends of the optical fibers, can no longer be accessed to pass a signal into an end of the optical fibers and/or to detect a light signal emanating from an end of the optical fibers.

It is one object of the present disclosure to provide hardware such as a termination apparatus for use with an overhead electrical cable that enables access to such optical fibers associated with the electrical cable, even after the overhead electrical cable has been installed, e.g., after a span of the overhead electrical cable has been strung and terminated.

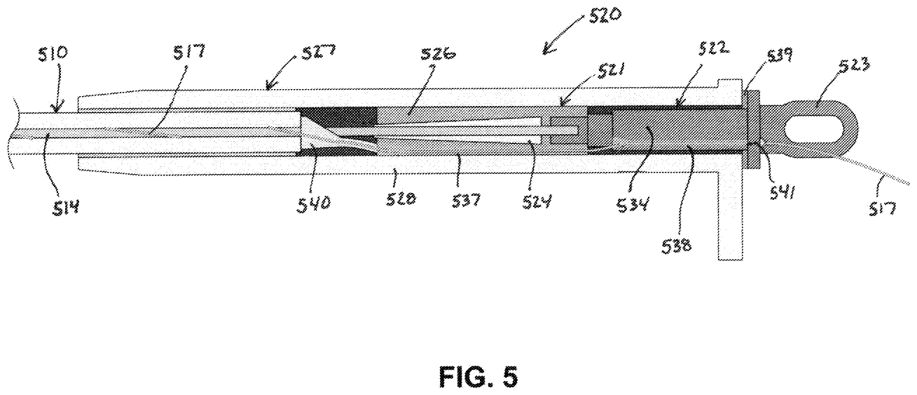

FIG. 5 illustrates one embodiment of a termination apparatus (e.g., a dead-end) for use with an overhead electrical cable that enables one or more optical fibers to be accessed from outside of the apparatus. As illustrated in FIG. 5, the dead-end 520 includes a gripping assembly 521 that grips a strength member 514 of an overhead electrical cable 510, e.g., so that the electrical cable 510 may be securely held at very high tension. Similar to the termination apparatus illustrated in FIG. 1, the gripping assembly 521 may be characterized as a compression wedge, particularly having a collet 524 and a collet housing 526 that is configured to receive the collet 524 within the housing 526.

The gripping assembly 521 includes a gripping assembly channel 537 (e.g., a groove or elongate notch) disposed along an external surface of the gripping assembly 521, particularly along an external surface of the collet housing 526. The channel 537 is configured (e.g., sized and shaped) to secure one or more optical fibers, such as optical fiber 517, within the channel 537, e.g., to contain and protect the optical fiber 517 between gripping assembly 521 and an internal surface of the conductive sleeve body 528. As illustrated in FIG. 5, the gripping assembly channel 537 runs along the outer surface of the gripping assembly 521 (e.g., of the collet housing 526) from one end of the gripping assembly 521 to the opposite end of the gripping assembly 521. Characterized another way, the channel 537 is disposed along at least that portion of the gripping assembly 521 that is in direct contact with the conductive sleeve body 528. Also, the gripping assembly channel 537 is disposed in a substantially linear manner along the gripping assembly 521. Although a linear configuration is more easily manufactured and implemented, it will be appreciated that the channel 537 may be non-linear if desired, e.g., may be helically disposed around the gripping assembly. In any event, the channel 537 enables the conductive sleeve body 528 to be crimped down upon the gripping assembly 521 (see FIG. 3) with the optical fiber 517 undergoing little or no compression such that the optical fiber 517 will be undamaged.

A connector 522 is operatively attached to the gripping assembly 521 and includes a connector body 534. The connector body 534 includes a connector body channel 538 disposed along (e.g., formed in) an external surface of the connector body 534. As with the gripping assembly channel 537, the connector body channel 538 is configured (e.g., sized and shaped) to secure, e.g., contain and protect, one or more optical fibers, e.g., optical fiber 517 within the channel 538. The connector body channel 538 is disposed along at least that portion of the connector body 534 that is in direct contact with the conductive sleeve body 528 and may be disposed along the entire length of the connector body 534. As with the gripping assembly channel 537, the connector body channel 538 may be disposed along the connector body 534 in a substantially linear manner as illustrated in FIG. 5 or may be disposed along the connector body 534 in a non-linear manner.

The connector 522, e.g., the connector body 534 may include connector body threads and the collet housing 526 may include connector mating threads that mate with (e.g., are threadably engaged with) the collet housing threads to secure the collet housing 526 to the connector 522, e.g., as illustrated in FIG. 2 above, although other means of securing the gripping assembly 521 to the connector 522 are contemplated. Further, a gripping device and a connector may be integrally formed, i.e., as a single unit.

To enable the termination apparatus 520 to be secured to a tower (see FIG. 1), the termination apparatus includes a fastener 523, e.g., that is operatively attached to or is integrally formed with the connector body 534 as is illustrated inf FIG. 5. A gasket 539 may separate the fastener 523 from the outer sleeve 527 to reduce the ingress of moisture and other foreign elements into the termination apparatus 520. As illustrated in FIG. 5, the fastener 523 is an eyebolt (e.g., having a single closed loop). However, other types of fasteners are contemplated, including a clevis-type fastener having two prongs with apertures enabling a clevis pin to be placed through the prongs. See, for example, U.S. Pat. No. 2,668,280 by Dupre and U.S. Pat. No. 6,338,590 by Stauske et al., each of which is incorporated herein by reference in its entirety.

As noted above, an outer sleeve 527 having a conductive sleeve body 528 defining a cavity is placed over the gripping assembly 521 and over the connector body 534. The outer sleeve 527 may be crimped (e.g., compressed) onto the underlying structure, e.g., onto the connector body 534 and onto the electrical cable 510 as is illustrated in FIG. 2

The termination apparatus 520 illustrated in FIG. 5 also includes a strain relief guide 540 that is configured to contain and redirect the optical fiber from the electrical cable 510 to the gripping assembly channel 537. In this regard, the strain relief guide 540 illustrated in FIG. 5 includes a tapered shape, e.g., in the nature of a cone or funnel. The strain relief guide 540 may be fabricated from a pliable material, such as an elastomeric material, for example. The strain relief guide 540 is configured to ensure that the optical fiber 517 is not subject to small radius bends that may damage or otherwise be detrimental to the efficacy of the optical fiber 517.

The optical fiber 517 extends from the termination apparatus 520 through a fiber egress aperture 541. The fiber egress aperture 541 is configured (e.g., sized and shaped) to enable one or a plurality of optical fibers through the aperture 541. Thus, a connection may be made to the optical fiber 517, such as a connection to an OTDR, BOTDR, or similar interrogation device, or to a telecommunications device.

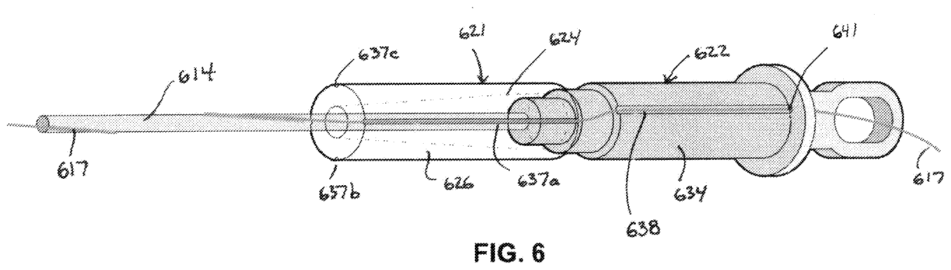

FIG. 6 illustrates a perspective view of a connector and gripping assembly according to an embodiment, e.g., that may be utilized in the termination apparatus illustrated in FIG. 5. The gripping assembly 621 is secured to a strength member 614 using a collet 624 and collet housing 626 arrangement. An optical fiber 617 is wrapped around the strength member 614, and may be utilized for interrogation (i.e., as a sensing element) and/or may be used for telecommunications (e.g., data transfer). The optical fiber 617 is disposed within a gripping assembly channel 637a which runs along the length of the gripping assembly 621, i.e., along the length of an outer surface of the collet housing 626. The collet housing 626 includes a plurality of gripping assembly channels 637a/637b/637c which may accommodate a plurality of optical fibers, or may be used with a single optical fiber, e.g., for purposes of alignment. Similarly, the connector 622 includes a connector body channel 638 linearly disposed along the surface of the connector body 634. The optical fiber extends 617 from the connector 622 through a fiber egress aperture 641.

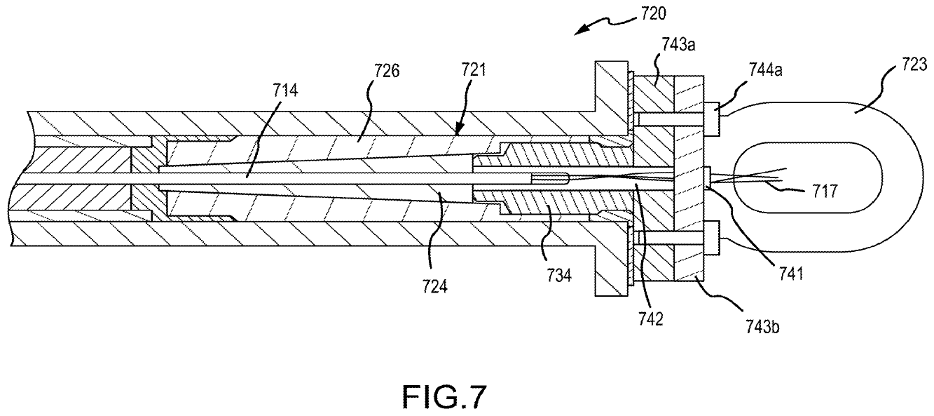

FIG. 7 illustrates a cross-sectional view of an alternative embodiment of a termination apparatus according to the present disclosure. The termination apparatus 720 includes a gripping assembly 721 in the form of a collet 724 and collet housing 726 that grip onto the strength member 714. In this embodiment, one or more optical fiber(s) 717 extend through the collet 724 with the strength member 714. In this regard, the connector body 734 includes a port 742 (e.g., a bore) extending longitudinally through the connector body 734 including a first flange 743a which may be integrally formed with the connector body 734. The fastener 723 includes a second flange 743b that is secured to the first flange 743a by a plurality of flange bolts such as flange bolt 744a. The optical fibers 717 extend through the connector body port 742 and through a fiber egress aperture 741 disposed through the second flange 743b so that an end of the optical fibers 717 may be accessed. In this embodiment, the optical fibers 717 may be inserted through the aperture 741 before the flange 743b is secured to the flange 743a using bolts 744a. A grommet (e.g., a rubber grommet) may be utilized to reduce the bending strain on the optical fibers 717 as they exit the aperture 741.

The foregoing embodiments illustrate termination apparatus wherein the optical fibers extend through and/or around the gripping assembly and the connector body and exit the termination apparatus near the fastener end. Alternatively, the termination apparatus may be configured to direct the optical fibers out of the termination apparatus at a location between the end of the electrical cable and the gripping assembly, i.e., so that the optical fibers do not pass through or around the gripping assembly or the connector. Further, it may be desirable to splice the optical fibers (e.g., a fusion splice or a mechanical splice) to one or more connecting optical fibers within the termination apparatus, e.g., to seal the splices within the termination apparatus.

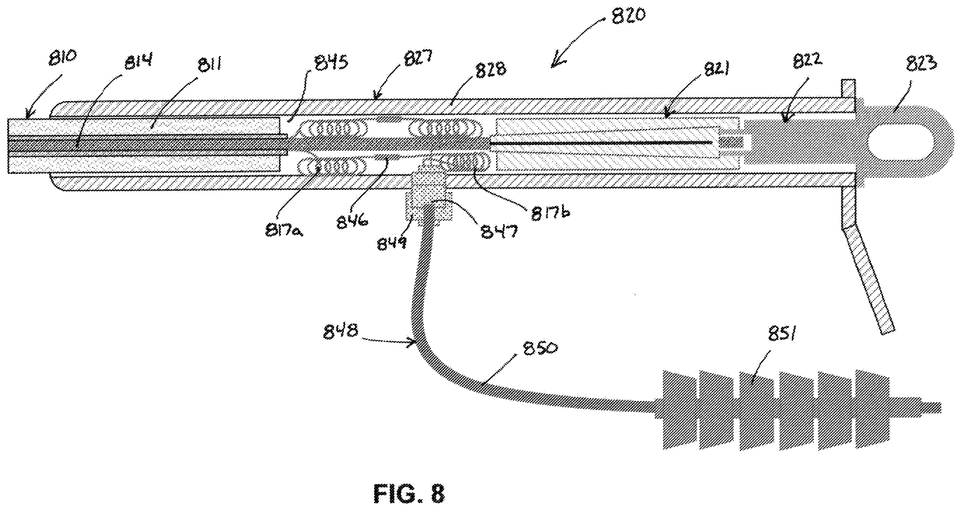

FIG. 8 illustrates one such embodiment of a termination apparatus 820. The termination apparatus 820 includes a gripping assembly 821 and a connector 822 having an integrally formed fastener 823 substantially as described above, with the exception of the optical fibers channels and apertures described with respect to FIGS. 5-7. As is illustrated in FIG. 8, the end of the electrical cable 810, i.e., of the electrical conductor 811, is spaced apart from the forward end of the gripping assembly 821 defining a working space 845 (e.g., bound by the conductive sleeve body 828) through which the strength member 814 extends to the gripping assembly 821. Each optical fiber such as optical fiber 817a associated with and extending from the electrical cable 810 is operatively connected to a second optical fiber 817b. The connection may be made using a splice, such as a fusion splice 846. The second optical fiber 817b is operatively connected to an optical fiber socket 847, which is at least partially disposed through a port (e.g., an aperture) in the conductive sleeve body 828. For example, the optical fibers 817b and the socket 847 may be provided as a pre-constructed device configured for this purpose. The socket 847 illustrated in FIG. 8 is also configured to attach to an optical fiber jumper 848, e.g., on an opposite side of the socket. Although described herein as a socket 847, the socket may be any device that provides a pathway (e.g., an operational light signal pathway) through the sleeve body 828. For example, the socket 847 may comprise a splice box. The socket 847 may also comprise a cord connector, e.g., a strain relief grip that reduces tension on the optical fiber 817b and provides a liquid tight seal around the optical fiber. The jumper 848 includes an appropriate fitting 849 and an armored cable 850 containing optical fibers. The fitting 849 is configured to operatively mate with the socket 847, e.g., to connect optical fibers 817b to optical fibers in the armored cable 850. An insulator string 851 may be operatively connected to the armored cable 850 if a reduction in voltage on the optical fibers is desired and/or to prevent tracking.

The termination apparatus illustrated in FIG. 8 may provide a number of advantages, particularly in terms of the installation of the termination apparatus 820 including operative connection of the optical fiber 817a to the exterior of the termination apparatus. For example, once the optical fiber 817a is separated from the end of the strength member 814, the strength member may be cut to its final length. The gripping assembly 821 (e.g., the collet and collet housing) may then be attached to and secured upon the strength member 814 following standard procedures. The loose optical fiber 817a may then be fusion spliced to the second optical fiber 817b which is pre-attached to the optical fiber socket 847. Optionally, protective buffer tubes may be placed over the optical fibers to protect optical fibers within the working space 845. The termination apparatus may then be assembled, i.e., the outer sleeve 827 may be positioned and crimped over the electrical cable 810 and the connector body 834. It is noteworthy that these steps may be performed on the ground, e.g., it is not necessary that the steps be performed while the overhead electrical cable is affixed (but not tensioned) high on a tower. The assembled termination assembly may then be lifted to the attachment point on the tower and attached to its insulator string. See FIG. 1. At that point, the prefabricated optical fiber jumper 848 may be connected by being inserted into the optical fiber socket 847 either before or after the electrical line is tensioned.

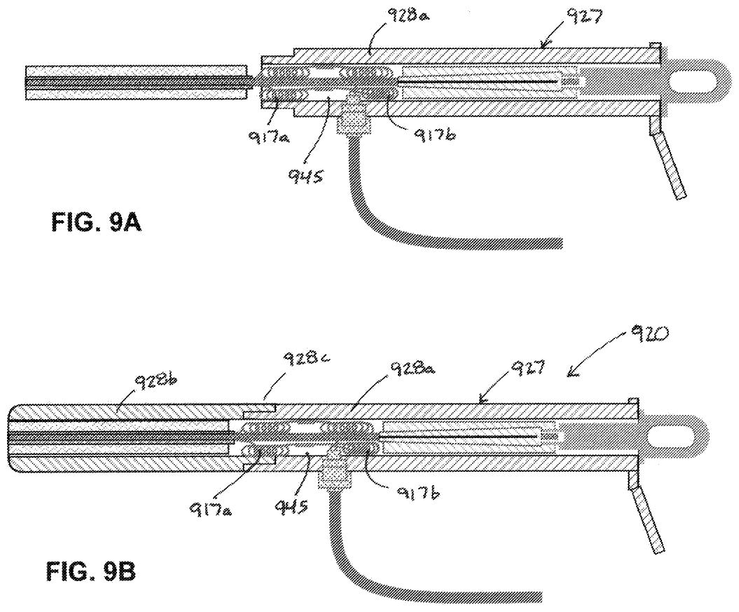

FIGS. 9A and 9B illustrate an alternative embodiment of a termination apparatus 920. The termination apparatus 920 is substantially similar to the termination apparatus illustrated in FIG. 8 with the exception of the configuration of the outer sleeve 927. As illustrated in FIGS. 9A and 9B, the conductive sleeve body is constructed from two portions 928a and 928b. The two portions 928a/928b are configured to operatively join at a location 928c that is disposed over, or is adjacent to, the working space 945 where the optical fibers 917a and 917b are located. At the joining location 928c the two portions of the conductive sleeve body operatively fit together, e.g., in the nature of a lap joint as illustrated in FIGS. 9A and 9B. After being placed together, the two portions 928a and 928b may be bonded to each other by crimping or a similar technique to provide a strong physical bond and an electrical pathway through the conductive sleeve body. One advantage of the embodiment illustrated in FIGS. 9A and 9B is that the optical fibers 917a and 917b may be spliced or otherwise worked upon in the working space 945 before the sleeve portion 928b is mated with and bonded to the sleeve portion 928a.

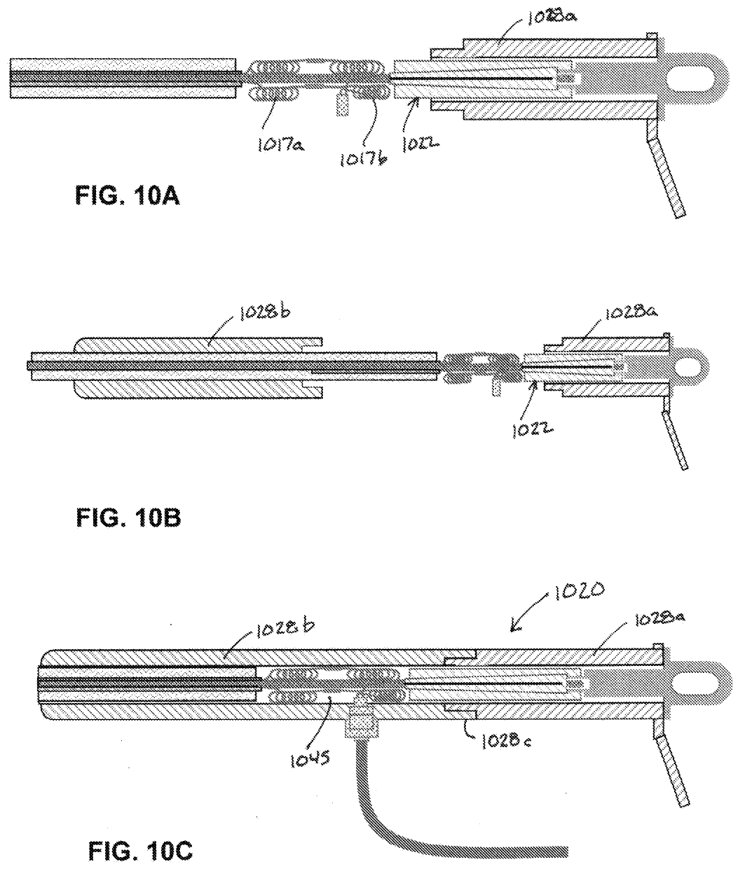

FIGS. 10A to 10C schematically illustrate another embodiment of a termination apparatus 1020 that is similar in construction to the termination apparatus illustrated in FIGS. 9A and 9B. In this embodiment, the two mating conductive sleeve body portions 1028a and 1028b are configured to join at a location 1028c that is disposed over the connector 1022 leaving the entire working space 1045 exposed (e.g., easily accessible) before the sleeve portion 1028b is mated to the sleeve portion 1028a. See FIG. 10B. As with the termination apparatus illustrated in FIGS. 9A and 9B, this construction may enable the optical fibers 1017a and 1070b to be spliced or otherwise worked upon before the sleeve portions 1028a/1028b are mated and bonded or otherwise affixed together.

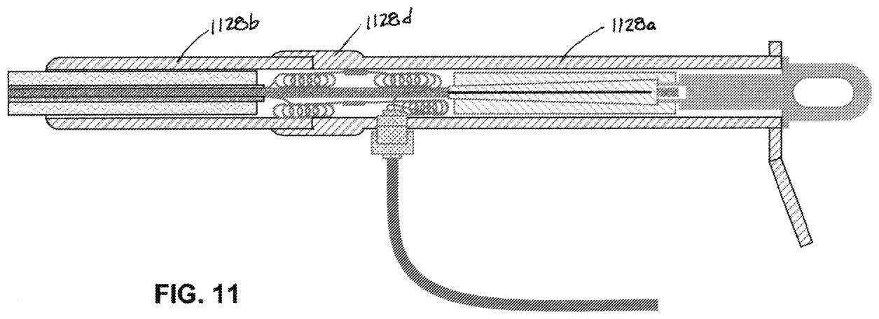

FIG. 11 illustrates a further embodiment of a termination apparatus similar to those illustrated in FIGS. 9A and 9B and in FIGS. 10A to 10C. In the embodiment illustrated in FIG. 11, the conductive sleeve body portion 1128a includes an end portion having an increased outer diameter 1128d to receive an end of the sleeve portion 1128b therein.

In the embodiments illustrated in FIG. 9A through FIG. 11, the conductive sleeve body, e.g., the outer sleeve, is segmented (e.g., partitioned or bifurcated) to facilitate access to the optical fibers and related components prior to final assembly of the termination apparatus. It will be appreciated that modifications may be made to the illustrated embodiments within the scope of the present disclosure. For example, the two portions of the conductive sleeve body may be joined using threaded bolts or other mechanical fasteners. Further, in each of the illustrated embodiments the conductive sleeve body is segmented through the longitudinal axis of the sleeve. However, the outer sleeve may be segmented along a longitudinal axis, e.g., in the nature of a clam shell.

FIGS. 12A and 12B illustrate an embodiment of a gripping assembly according to the present disclosure, where FIG. 12A is a perspective view and FIG. 12B is a cross-sectional view. For example, the gripping assembly illustrated in FIGS. 12A and 12B may be utilized in the embodiments illustrated in FIG. 5 and FIG. 6. The gripping assembly includes a collet 1224 and a mating collet housing 1226. The collet housing 1226 includes two gripping assembly channels 1237a and 1237b that are configured to secure one or more optical fibers therein as illustrated in FIG. 5 and FIG. 6. Although illustrated as comprising two such channels, the collet housing may include one or any number of such channels.

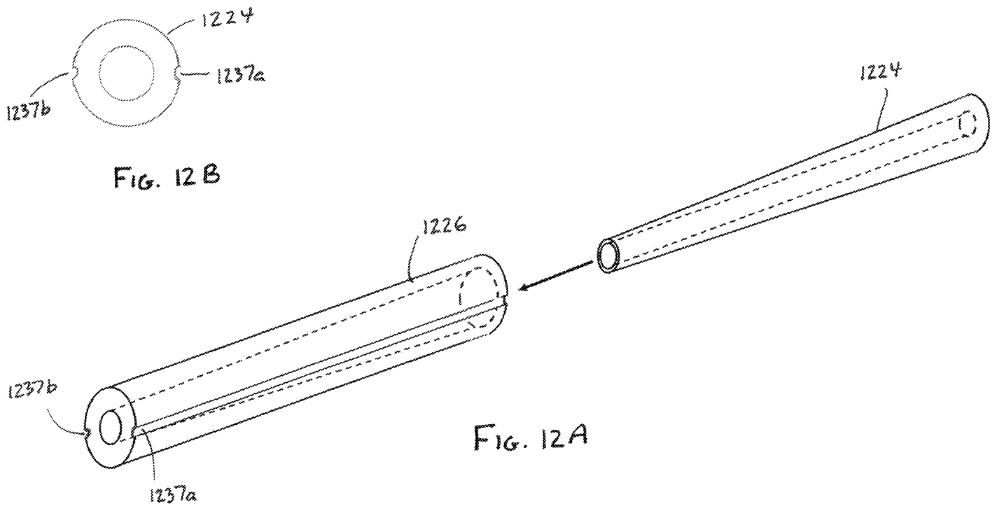

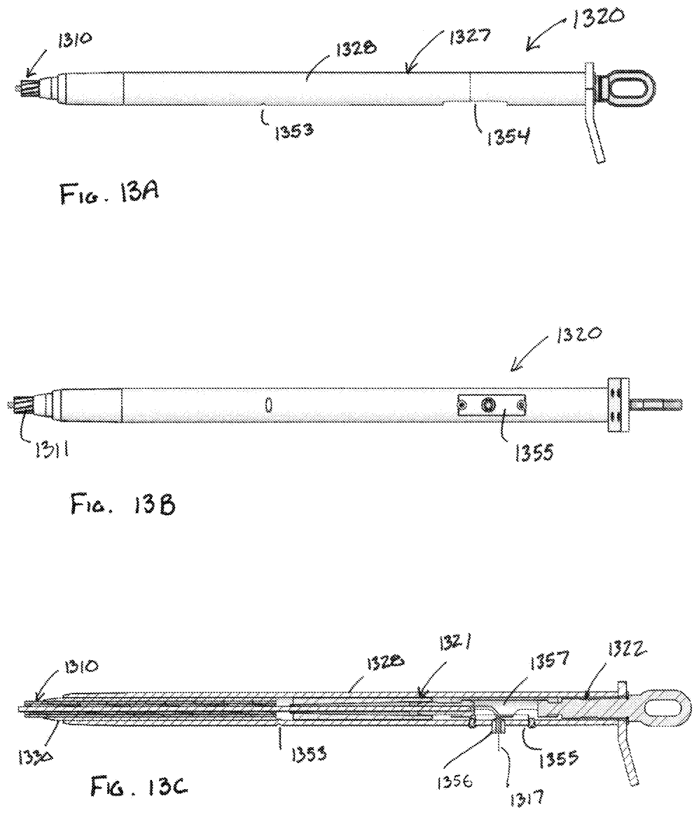

According to another embodiment of the present disclosure, a termination apparatus is constructed with a window port through the conductive sleeve body to permit access to the optical fiber(s) through the window port, e.g., so that the optical fiber may be manipulated through the window port. The window port may be sealed from the environment using a window port cover, e.g., a removable window port cover. FIGS. 13A to 13C illustrate different views of one example of such a termination apparatus. The termination apparatus 1320 securely grips an overhead electrical cable 1310, e.g., in a manner illustrated above with respect to FIGS. 8 to 11. The outer sleeve 1327 includes a conductive sleeve body 1328 which is placed over and surrounds the gripping element 1321 and the connector 1322. A window port 1354 is formed through the conductive sleeve body 1328 to enable access to the optical fiber 1317 within the conductive sleeve body 1328. In this manner, the termination apparatus 1320 may be fully assembled in the field and the optical fiber 1317 may accessed through the window port to manipulate the optical fiber 1317, e.g., to place the optical fiber through a ferrule 1356, enabling the optical fiber to be accessed after the window port cover 1355 is placed back over the window port 1354, e.g., using bolts or a similar fastener. In addition, the conductive sleeve body 1328 illustrated in FIGS. 13A-13C includes a dimple 1353 (e.g., an indentation) formed in the sleeve. Such a dimple 1353 is configured to prevent movement of the inner sleeve 1330 that is disposed between the conductor 1311 and the conductive body 1328 to facilitate the electrical connection between the conductor 1311 and the conductive body 1328.

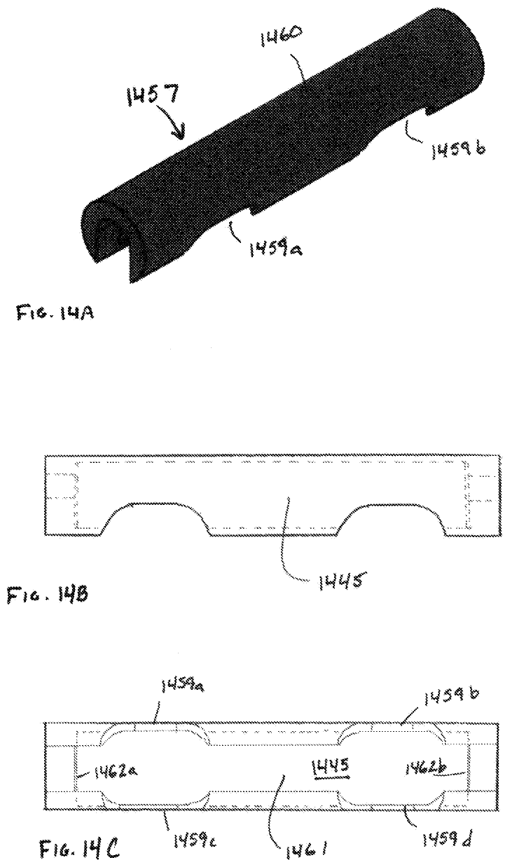

As illustrated in FIG. 13C, the connector 1322 is formed in two sections that are operatively joined using a spacer clip 1357 that is disposed between the two connector sections. FIGS. 14A to 14C illustrate different views of such a spacer clip 1457. The spacer clip 1457 is generally cylindrical in form, e.g., having a generally cylindrical and open side wall 1460. An access slot 1461 formed in the cylindrical side wall 1460 enables access to a working space 1445, e.g., where the optical fiber may be partially disposed in the working space 1445 when the termination apparatus in assembled (See FIG. 13C). Button notches 1459a to 1459d are provided in the side wall to enable the spacer clip 1457 to be operatively secured to the two sections of the connector. The ends of the working space 1445 are partially confined by interior wall segments 1462a and 1462b which are configured to hold the two connector segments when the termination apparatus is assembled. The spacer clip 1457 may be fabricated from a high-strength material such as steel, e.g., stainless steel.

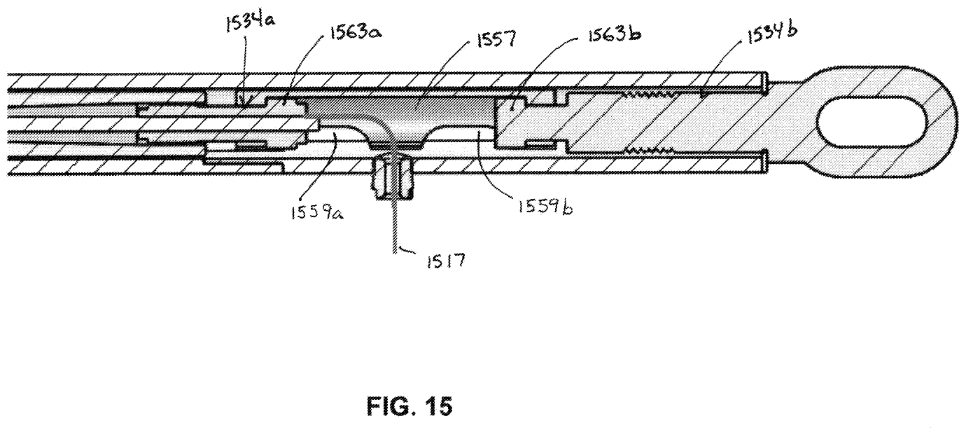

FIG. 15 illustrates a close-up cross-sectional view of a portion of the termination apparatus illustrated in FIGS. 13A to 13C, particularly illustrating the assembly of the spacer clip with the two sections of the connector. The two connector sections 1534a (gripping assembly end) and 1534b (fastener end) each include a button 1563a and 1563b that is placed within the spacer clip 1557, e.g., where the buttons 1563a/1563b are inserted through the button notches 1559a/1559b and secured against the interior wall segments of the spacer clip 1557. In this manner, the optical fiber 1517 passes through and can be manipulated within the working space 1545 defined by the spacer clip 1557.

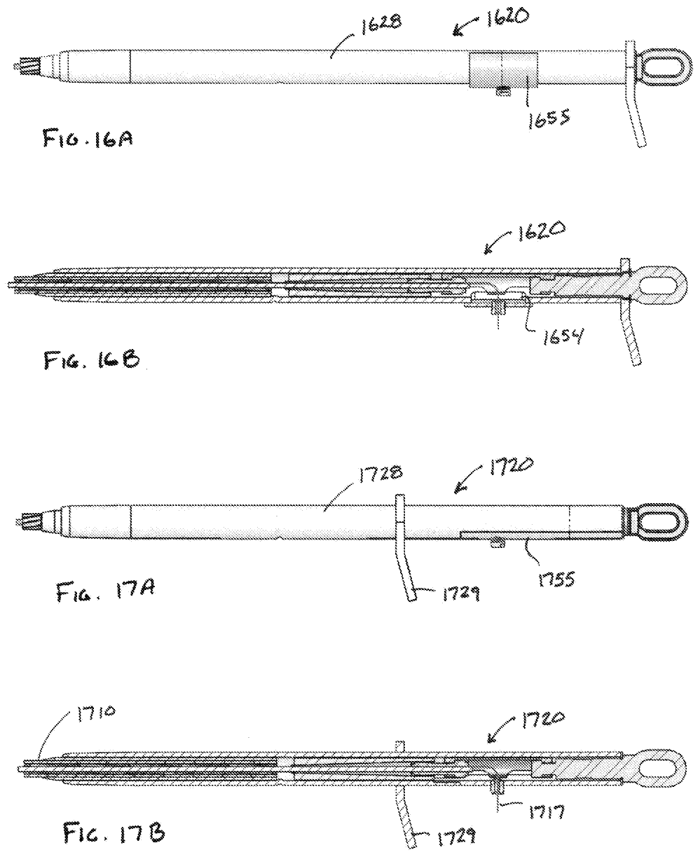

Other variations of the foregoing embodiments are envisioned by the present disclosure. For example, FIGS. 16A and 16B illustrate a termination apparatus 1620 that is similar in construction to the termination apparatus described above with respect to FIGS. 13A to 13C, e.g., including a window port 1654 and a window port cover 1655. As illustrated in FIGS. 16A and 16B, the window port cover 1655 is semi-cylindrical and covers a larger portion of the circumference of the conductive sleeve body 1628. This enables the underlying port 1654 to be larger, e.g., to also extend over a larger circumference of the conductive sleeve body 1628.

FIGS. 17A and 17B illustrate a termination apparatus 1720 that is also similar in construction to the termination apparatus illustrated in FIGS. 13A to 13C. In this embodiment, the jumper plate 1729 is affixed to the conductive sleeve body 1728 at a position between the electrical cable 1710 and the port where the optical fiber 1717 exits the termination apparatus. As a result, the electricity will flow from the electrical cable 1710 and be directed to the next cable segment by the jumper plate 1729 before reaching the exit point of the optical fiber, reducing the electrical potential experienced by the optical fiber 1717 and therefore reducing the opportunity for damage to or faulty readings from the optical fiber 1717. It will be appreciated that the placement of the jumper plate in this manner, e.g., in front of the optical fiber exit point, can be applied to any of the embodiments of a termination arrangement disclosed herein.

The embodiments illustrated in FIGS. 5 to 17 are presented as examples of termination apparatus, components of termination apparatus and methods for terminating an electrical cable. These embodiments are intended to be illustrative and non-limiting, and the embodiments are subject to a number of modifications. For example, the foregoing embodiments illustrate a gripping assembly in the form of a wedge clamp, e.g., in the form of a collet disposed in a collet housing. However, the gripping assembly may take other forms, such as a crimp-style gripping assembly, where the strength member is placed in a tube and the tube is radially crimped (e.g., compressed) onto the strength member. One example of this style of gripping assembly is illustrated in U.S. Pat. No. 6,805,596 by Quesnel et al. (AFL) which is incorporated herein by reference in its entirety. The gripping assembly illustrated by Quesnel et al. is integrally formed with a connector and comprises a steel tube for receiving the strength member therein. An aluminum sleeve is placed between the strength member and the steel tube, and the steel tube is then crimped onto the strength member.

The foregoing embodiments are directed to termination apparatus that permit the egress of optical fibers, e.g., so that the optical fibers may be isolated and selectively interrogated or used for telecommunication purposes. As described with respect to FIG. 1, many electrical transmission and distribution lines also include splices wherein two electrical cable segments are electrically and mechanically joined together, e.g., at a location between two support towers. Many of the concepts disclosed above for the egress of one or more optical fibers from a termination apparatus can be applied to a splice to ensure continuity of the optical fiber through the splice.

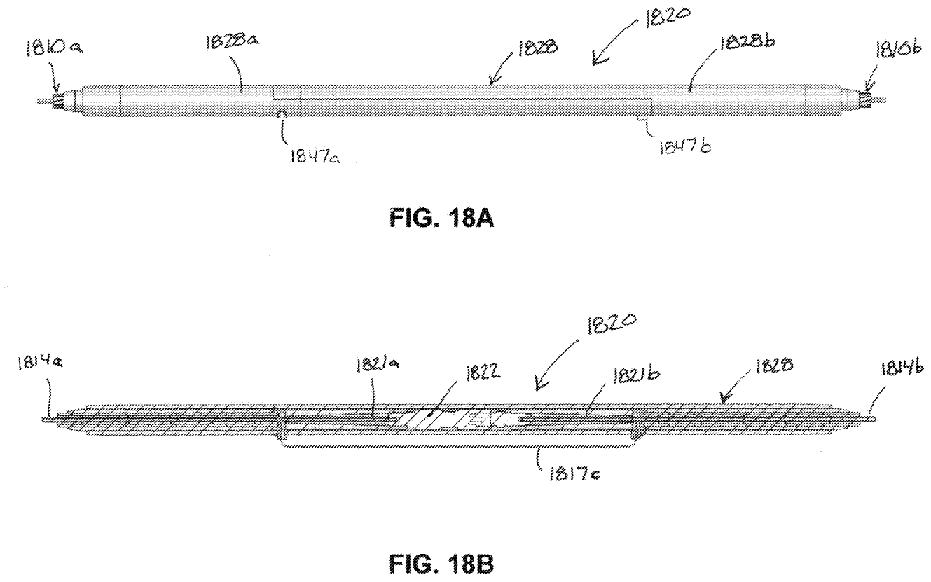

FIG. 18 illustrates one embodiment of a splice assembly according to the present disclosure. The splice assembly 1820 electrically and mechanically joins two overhead electrical cable segments 1810a and 1810b. The electrical connection is facilitated by a conductive sleeve body 1828 that is in electrical contact with each cable segment 1810a/1810b such that electricity may pass from one cable to the other through the conductive sleeve. On the interior of the splice assembly 1820, the two cable segments 1810a and 1810b are mechanically joined by a connector 1822. Specifically, the connector 1822 mechanically joins two gripping assemblies 1821a and 1821b that grip the strength members 1814a and 1814b of cable segments 1810a and 1810b respectively. As illustrated in FIGS. 18A and 18B, an optical fiber segment 1817c joins an optical fiber associated with electrical cable 1810a to an optical fiber associated with electrical cable 1810b, e.g., through optical fiber sockets 1847a and 1847b. As illustrated in FIG. 18A, the conductive sleeve body 1828 is formed using two segments 1828a and 1828b that are longitudinally split along a portion of the length of the conductive body 1828, e.g., in a dovetail fashion. In this manner, the interior of the splice 1820, including the optical fibers, may be accessed and manipulated after the two cable segments 1810a and 1810b are mechanically joined. Thereafter, the two conductive body segments 1828a and 1828b may be assembled to complete the splice assembly 1820.

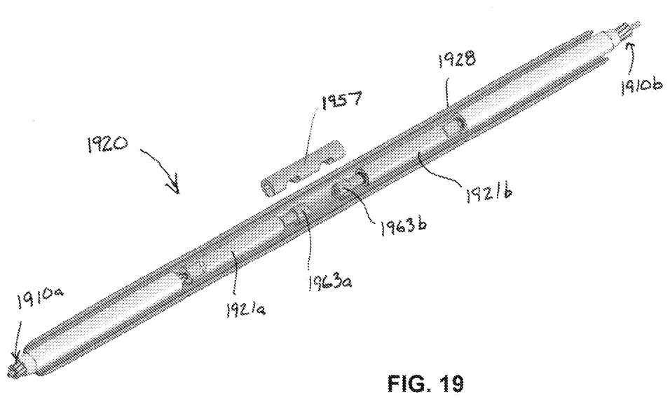

In another embodiment, the splice assembly may include a spacer clip arrangement similar to the spacer clip arrangement illustrated in FIGS. 13 to 15 above. FIG. 19 illustrates an exploded view of such a splice assembly. The splice assembly 1920 mechanically and electrically joins two electrical cable segments 1910a and 1910b. A conductive sleeve 1928 provides an electrical connection between the cable segments 1910a and 1910b. Gripping assemblies 1921a and 1921b are secured to electrical cable segments 1910a and 1910b respectively, i.e., by gripping onto the respective strength members. Each of the gripping assemblies 1921a and 1921b includes a button 1963a and 1963b that is configured to be secured within the spacer clip 1957, e.g., by being passed through button notches in the spacer clip 1957. See FIGS. 14 to 15. Thus, as with the termination arrangements disclosed above with respect to FIGS. 13 to 15, the spacer clip 1957 advantageously provides a working space for the manipulation of optical fibers within the splice assembly 1920, e.g., through a window port as illustrated in FIGS. 13A to 13C.

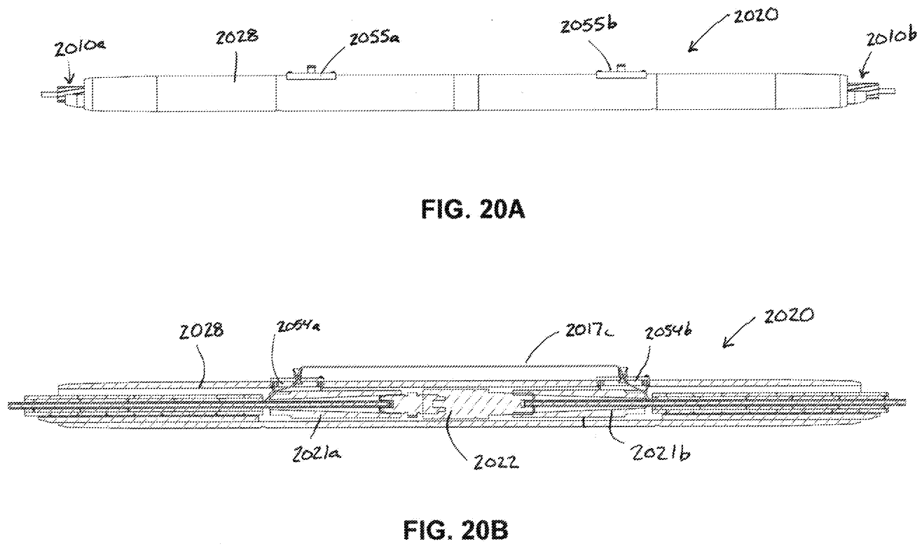

FIGS. 20A and 20B illustrate a further embodiment of a splice assembly that incorporates window ports for access to and/or routing of optical fiber(s). The splice assembly 2020 includes two window ports 2054a and 2054b through the conductive body 2028 that enable access to the interior of the splice assembly. The window ports 2054a and 2054b are located on opposite sides of a connector 2022 that joins the gripping assemblies 2021a and 2021b. The window ports 2054a and 2054b are also located near the ends of the electrical cable segments 2010a and 2010b to enable ease of access to the optical fibers that extend from the electrical cables. As illustrated in FIG. 20, an optical fiber segment 2017c is operatively connected to the optical fibers extending from the electrical cables 2010a and 2010b, e.g., using a fiber splice, and is routed through the window ports 2054a and 2054b to avoid passing through the gripping assemblies and the connector. As with the termination apparatus disclosed above, removable window port covers 2055a and 2055b cover and seal the window ports 2054a and 2054b and permit access to the interior of the splice assembly during and after assembly of the splice.

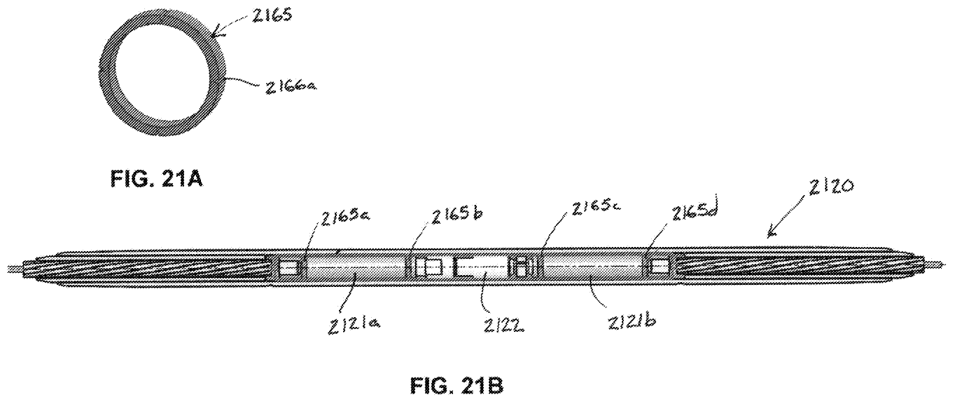

FIGS. 21A and 21B illustrate another embodiment of a splice assembly that incorporates an optical fiber ring to enable optical fiber(s) to be passed through the interior of the splice assembly. FIG. 21A illustrates the optical fiber ring 2165. The ring 2165 is generally round and includes at least one, and preferably more than one, optical fiber retaining notch 2166a in the circumference of the ring 2165. The retaining notch 2166a is configured, e.g., is sized and shaped, to hold an optical fiber that passes through the notch 2166a. The retaining ring 2165 may be fabricated from an elastic material such as a high temperature elastomer. As illustrated in FIG. 21B, a plurality of rings 2165a to 2165d may be placed around the gripping assemblies 2121a and 2121b, e.g., at the opposite ends of each gripping assembly. Thus, the rings 2165a to 2165d are sized and shaped to closely fit, e.g., to friction fit, over the exterior of the gripping assemblies. The optical fiber notches will then be positioned to enable one or more optical fibers to pass over the gripping assemblies 2121a and 2121b and through the splice while reducing the chance of damage to the optical fibers.

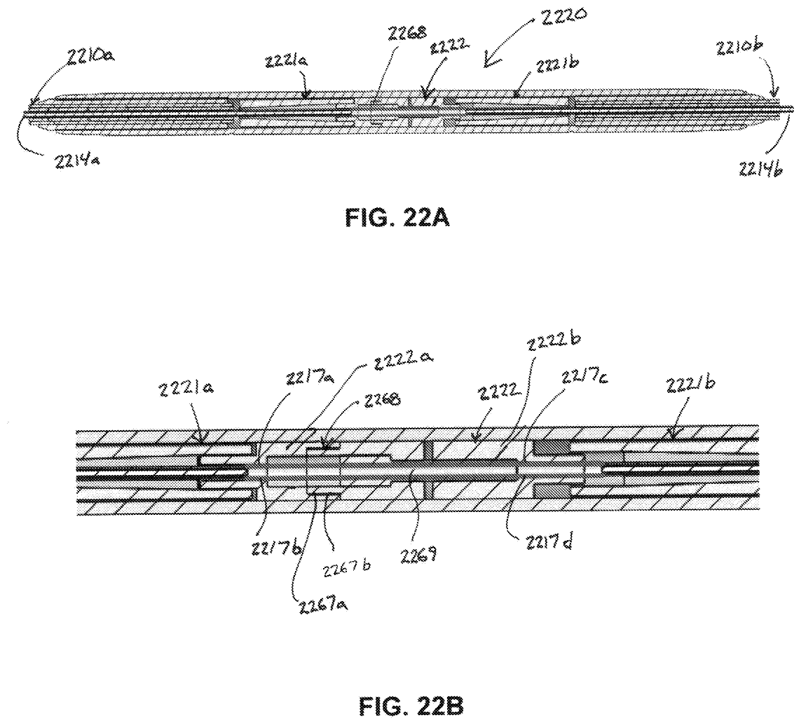

FIGS. 22A and 22B illustrate another embodiment of a splice assembly according to the present disclosure. The splice assembly 2220 mechanically and electrically joins two cable segments 2210a and 2210b. Specifically, the connector 2222 mechanically joins two gripping assemblies 2221a and 2221b that grip the strength members 2214a and 2214b of cable segments 2210a and 2210b respectively. The connector 2222 includes two portions 2222a and 2222b that are threadably connected by mating threads 2267a and 2267b disposed on the two connector portions 2222a and 2222b. One threaded portion 2267b associated with connector portion 2222b is configured to rotate freely about its longitudinal axis to mate to the threaded portion 2267a on the connector portion 2222a. That is, the threaded portion 2267b is configured to rotate and mate to threads 2267a without requiring the entire connector portion 2222b to also rotate.

As illustrated in FIG. 22B, optical fiber segment 2217a associated with cable 2210a is operatively spliced to optical fiber 2217c associated with electrical cable 2210b, and optical fiber 2217b is operatively spliced to optical fiber 2217d. The splices, e.g., fusion splices, are contained within the connector 2222, and specifically are contained within a bore 2269 that extends through the connector 2222. As a result, the splices connecting the optical fibers may be made before threadably mating the two portions 2222a/2222b of the connector 2222. Specifically, the optical fibers 2217a and 2217b may be inserted through the bore 2269 in the first portion 2222a and the optical fibers 2222b may be inserted through the bore 2269 in the second portion 2222b. After the splices are completed, the two connector portions 2222a and 2222b may be brought together and threadably connected with the splices being contained within the bore 2269. Because the threads 2267b rotate freely, the mating of the two connector portions 2222a and 2222b will not cause stresses, e.g., torsional stresses, to be placed on the optical fibers or the splices during construction of the splice assembly 2220 on the electrical line.

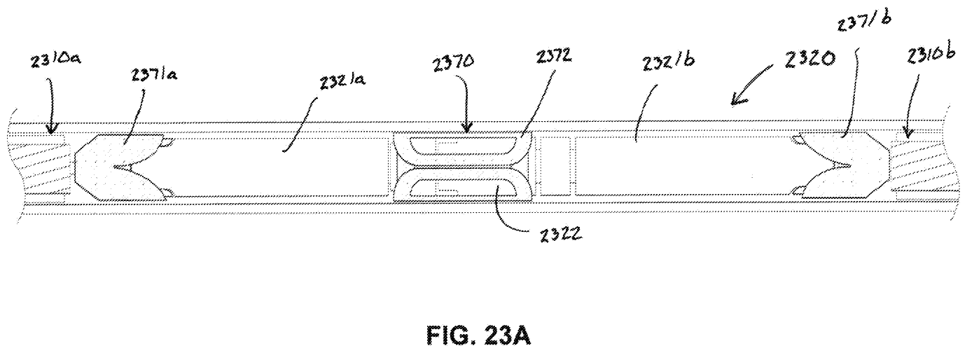

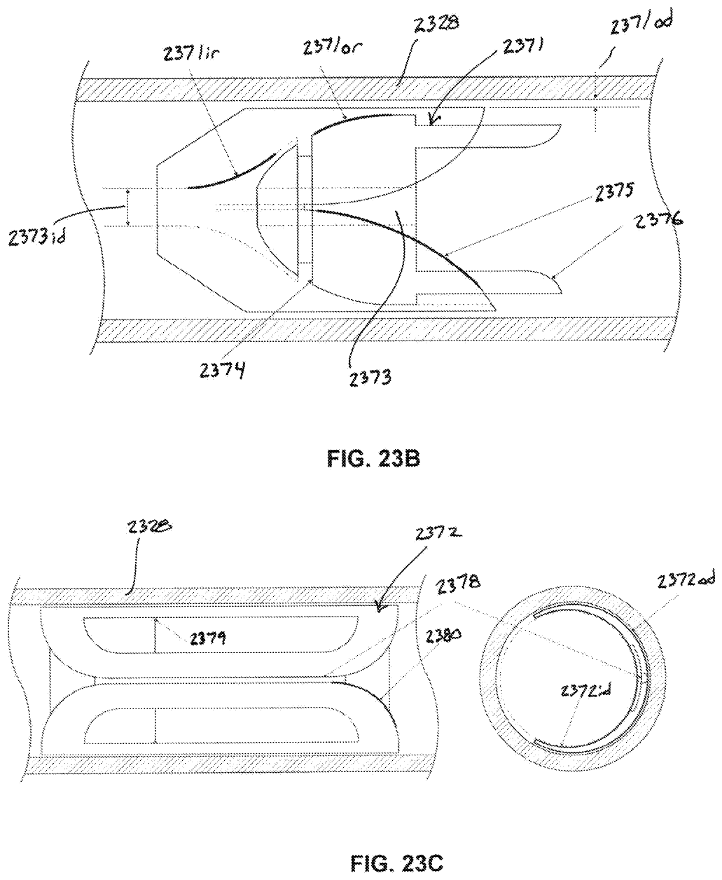

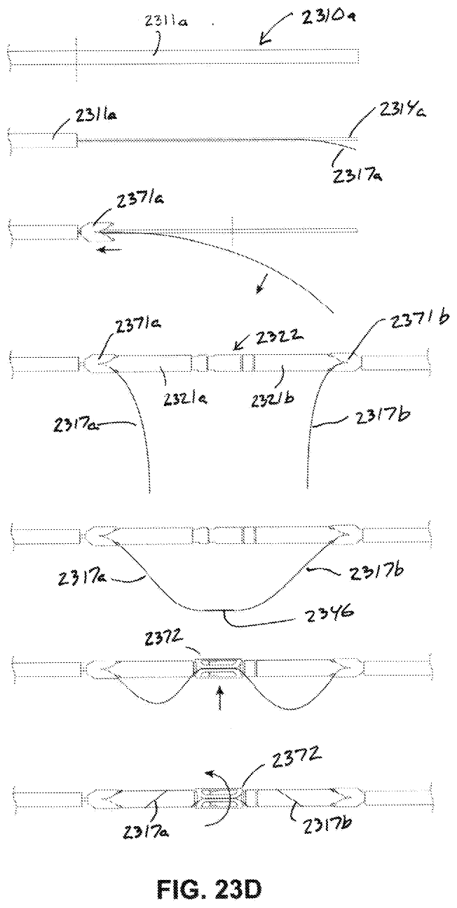

FIGS. 23A to 23C illustrate a splice assembly including a take-up bobbin system that is configured to protect and manage an optical fiber between the inner and outer splice hardware components. FIG. 23A illustrates a partial cross-section of a splice assembly 2320 incorporating such a bobbin system 2370. The bobbin system 2370 is comprised of three components, namely two cone fittings 2371a and 2371b located at the respective ends of gripping assemblies 2321a and 2321b, and a take-up bobbin 2372 disposed between the two cone fittings 2371a and 2371b, e.g., over a connector 2322.

The cone fittings 2371a/2371b are configured to guide one or more optical fibers from the strength members, e.g., from the surface of the strength members, over the edge of the gripping assemblies 2321a/2321b while maintaining a minimum bend radius in the optical fibers to reduce the likelihood that the optical fibers will be damaged during assembly. Referring to FIG. 23B, the cone fitting 2371a comprises a bore 2372 having an inner diameter 2373id configured (e.g., sized and shaped) to align the cone fitting 2371 to the strength member, e.g., to be placed over an end of the strength member. An inner radius surface 2371ir is configured to guide the optical fiber up from the strength member while maintaining a minimum bend radius. An outer radius surface 2371or is configured to guide the filament down, e.g., substantially tangent to the exterior surface of the gripping assembly. A surface cut feature 2375, e.g., a notch, is configured to guide the optical fiber into a helix around the outer diameter of the gripping assembly 2321a while also maintaining a minimum bend radius for the optical fiber. A forked protrusion 2376 prevents the optical fiber from catching on flat surfaces of the gripping assembly 2321a, such as on housing wrench flats. A swivel joint 2374 enables rotation of the outer radius surface 2371or relative to the surface cut feature 2375, allowing the outer radius surface 2371or and the surface cut feature 2375 to be brought into alignment, e.g., into clock alignment. The cone fitting has an outer diameter that is small enough to fit within the conductive sleeve 2328, but large enough to prevent strain between the cone fitting 2371, the optical fiber and the conductive sleeve 2328.

Referring to FIG. 23C, The take-up bobbin 2372 is configured to control the geometry, e.g., the bending, of the optical fiber(s) to maintain a minimum a bend radius. In this regard, the bobbin 2372 includes a clip feature 2378 to locate a splice, e.g., a fusion splice to join two optical fibers. An inner diameter 2372id is matched to the gripping assembly, enabling the bobbin 2372 to clip into place and freely rotate about its longitudinal axis. An inner lip feature 2379 is configured to locate the bobbin 2372 on the end of the gripping assembly. A surface cut feature 2380 is configured to guide the optical fiber into a helix around the outer diameter of the gripping assembly, accounting for the width of the fusion splice sleeve, while maintaining a minimum bend radius. An outer diameter 2372od of the bobbin 2372 is small enough to fit within the conductive sleeve 2328, but large enough to prevent strain between the bobbin 2372, the optical fiber and the conductive sleeve 2328.

FIG. 23D schematically illustrates a method for the use of the bobbin system according to the present disclosure. The conductor 2311a of the electrical cable segment 2310a is trimmed from the strength member 2314a, e.g., leaving a length of the strength member 2314a and the optical fiber 2317a exposed. The conductive sleeve (not illustrated) is slid over the electrical cable 2311a. The optical fiber 2317a is separated from the strength member 2314a, e.g., is peeled away from the surface of the strength member. A similar process is carried out to strip the electrical cable segment on the opposite side and to separate the optical fiber. Cone fittings 2371a and 2371b are installed on both ends of the strength members and the optical fibers 2317a and 2317b are threaded through the cone fittings 2371a and 2371b. The strength members are then trimmed, leaving the ends of the optical fibers 2317a and 2317b free from the strength members.

The splice assembly components, e.g., the gripping assemblies 2321a and 2321b and connector 2322 are installed while leaving the optical fibers 2317a and 2317b free. The two free ends of the optical fibers 2317a and 2317b are then spliced, e.g., forming a fusion splice 2346. Since the free length of the spliced optical fibers 2317a and 2317b exceeds the length of the splice assembly 2310a, the optical fibers hang in a loop below the splice assembly. To manage the excess length of the optical fibers, the take-up bobbin 2372 is installed onto the connector 2322, and the fusion splice 2346 is clipped into the center of the bobbin. The cone fittings 2371a and 2371b are then pressed onto the ends of the gripping assemblies and the bobbin 2372 is rotated around the connector axis until substantially all slack is out of the optical fibers 2317a and 2317b.

The foregoing embodiments illustrate the termination apparatus and splice assemblies, components and methods being implemented with a fiber-reinforced composite strength member having a single strength element. However, these embodiments may also be implemented with multi-element strength members (e.g., FIG. 4B), whether fabricated from a fiber-reinforced composite material or from traditional materials such as steel as in an ACSR (aluminum conductor steel reinforced) configuration or an ACSS (aluminum conductor steel supported) configuration. The embodiments may also be implemented with an aluminum multi-element strength member, such as in a AAAC (all aluminum alloy conductor) configuration. In addition, the embodiments may be implemented with an OPGW (optical ground wire).

Certain components of the foregoing termination apparatus and splice assemblies may be fabricated from high strength metals such as steel, including stainless steel. These include the gripping assemblies, e.g., the collet and housing components, and the connectors. Components requiring higher electrical conductivity, such as the conductive sleeves, may be fabricated from aluminum for example.

While various embodiments of termination apparatus, splice and methods for the termination and splicing of an overhead electrical cable have been described in detail, it is apparent that modifications and adaptations of those embodiments will occur to those skilled in the art. However, it is to be expressly understood that such modifications and adaptations are within the spirit and scope of the present disclosure.

What is claimed is:

1. A termination apparatus for use with an overhead electrical cable, comprising:
a gripping assembly configured to grip a strength member of an overhead electrical cable, the gripping assembly comprising a gripping assembly channel disposed along an external surface of the gripping assembly that is configured to secure one or more optical fibers within the gripping assembly channel; and
a connector integrally formed with or configured to be operatively attached to the gripping assembly and comprising a connector body and a connector body channel disposed along an external surface of the connector body that is configured to secure the one or more optical fibers within the connector body channel.

2. The termination apparatus recited in claim 1, wherein the gripping assembly comprises a compression wedge.

3. The termination apparatus recited in claim 2, wherein the compression wedge comprises a collet and a collet housing that is configured to receive the collet within the collet housing.

4. The termination apparatus recited in claim 3, wherein the gripping assembly channel is disposed on an outer surface of the collet housing.

5. The termination apparatus recited in and one of claims 3 or 4, wherein the connector body comprises connector body threads and wherein the collet housing comprises collet housing threads, wherein the connector body threads are configured to mate with the collet housing threads to threadably secure the collet housing to the connector body.

6. The termination apparatus recited in any one of claims 1 to 5, wherein the gripping assembly channel runs from one end of the gripping assembly to a second end of the gripping assembly.

7. The termination apparatus recited in claim 6, wherein the gripping assembly channel runs along the external surface of the gripping assembly in a substantially linear manner.

8. The termination apparatus recited in any one of claims 1 to 7, wherein the connector body channel runs from a first end of the connector body to a second end of the connector body.

9. The termination apparatus recited in claim 8, wherein the connector body channel runs along the external surface of the connector body in a substantially linear manner.

10. The termination apparatus recited in any one of claims 1 to 9, further comprising an outer conductive sleeve comprising a conductive body and a cavity within the conductive body, wherein the conductive body is configured to be placed over the gripping assembly and over the connector when the gripping assembly is operatively attached to the connector.

11. The termination apparatus recited in any one of claims 1 to 10, comprising a fastener operatively attached to the connector body.

12. The termination apparatus recited in claim 11, wherein the fastener is integrally formed with the connector body.

13. The termination apparatus recited in any one of claim 11 or 12, wherein the fastener comprises an eyebolt.

14. The termination apparatus recited in any one of claims 1 to 13, further comprising a strain relief guide having a guide aperture that is configured to redirect an optical fiber from an electrical cable to the gripping assembly channel.

15. The termination apparatus recited in any one of claims 1 to 14, further comprising an optical fiber aperture that is configured to facilitate passage of an optical fiber through the aperture.

16. The termination apparatus recited in claim 15, wherein the optical fiber aperture is disposed at an end of the connector.

17. A termination apparatus securing an overhead electrical cable having a strength member, an electrical conductor surrounding the strength member and one or more optical fibers associated with the electrical cable, the apparatus comprising:
a gripping assembly gripping the strength member, the gripping assembly comprising a gripping assembly channel disposed along an external surface of the gripping assembly;
a connector integrally formed with or operatively attached to the gripping assembly and comprising a connector body and a connector body channel disposed along an external surface of the connector body;
at least a first optical fiber disposed within the gripping assembly channel and within the connector body channel.

18. The termination apparatus recited in claim 17, wherein the gripping assembly comprises a compression wedge.

19. The termination apparatus recited in claim 18, wherein the compression wedge comprises a collet and a collet housing that receives the collet within the collet housing.

20. The termination apparatus recited in claim 19, wherein the gripping assembly channel is disposed on an outer surface of the collet housing.

21. The termination apparatus recited in and one of claim 19 or 20, wherein the connector body comprises connector body threads and wherein the collet housing comprises collet housing threads, wherein the connector body threads are operatively engaged with the collet housing threads to threadably secure the collet housing to the connector body.

22. The termination apparatus recited in any one of claims 17 to 21, wherein the gripping assembly channel runs from one end of the gripping assembly to a second end of the gripping assembly.

23. The termination apparatus recited in claim 22, wherein the gripping assembly channel runs along the external surface of the gripping assembly in a substantially linear manner.

24. The termination apparatus recited in any one of claims 17 to 23, wherein the connector body channel runs from a first end of the connector body to a second end of the connector body.

25. The termination apparatus recited in claim 24, wherein the connector body channel runs along the external surface of the connector body in a substantially linear manner.

26. The termination apparatus recited in any one of claims 17 to 25, further comprising an outer conductive sleeve comprising a conductive body and a cavity within the conductive body, wherein the conductive body is disposed over the gripping assembly and over the connector.

27. The termination apparatus recited in any one of claims 17 to 26, comprising a fastener operatively attached to the connector body.

28. The termination apparatus recited in claim 27, wherein the fastener is integrally formed with the connector body.

29. The termination apparatus recited in any one of claim 27 or 28, wherein the fastener comprises an eyebolt.

30. The termination apparatus recited in any one of claims 17 to 29, further comprising a strain relief guide having a guide aperture that redirects the optical fiber from the electrical cable to the gripping assembly channel.

31. The termination apparatus recited in any one of claims 17 to 30, further comprising an optical fiber aperture, wherein the optical fiber passes through the aperture to enable access to an end of the optical fiber.

32. The termination apparatus recited in claim 31, wherein optical fiber aperture is disposed at an end of the connector.

33. A termination apparatus securing an overhead electrical cable having a strength member, an electrical conductor surrounding the strength member and one or more optical fibers associated with the electrical cable, the apparatus comprising:
a gripping assembly gripping the strength member;
a connector integrally formed with or operatively attached to the gripping assembly and comprising a connector body and a connector body bore extending through the connector body; and
at least a first optical fiber disposed through the connector body bore.

34. A termination apparatus for use with an overhead electrical cable having a central strength member and an electrical conductor disposed over the strength member, comprising:
a gripping assembly configured to grip the strength member of the overhead electrical cable;
a connector integrally formed with or configured to be operatively attached to the gripping assembly;
an outer sleeve comprising a sleeve body defining a cavity therein, wherein the sleeve body comprises an aperture therethrough that is positioned to be disposed between the gripping assembly and an end of the electrical conductor when the outer sleeve is operatively crimped over the gripping assembly and the connector; and
an optical fiber socket configured to be operatively placed within the aperture to provide an optical fiber connection through the outer sleeve.

35. A gripping assembly configured for use with a termination arrangement for an overhead electrical cable having a strength member, an electrical conductor surrounding the strength member and one or more optical fibers associated with the electrical cable, the gripping assembly comprising:
a lumen disposed through the gripping assembly, the lumen being configured to operatively receive the strength member of the electrical cable therein; and
a channel disposed on an outer surface of the gripping assembly and running from a first end of the gripping assembly to a second end of the gripping assembly, the channel being configured to receive the one or more optical fibers therein.

36. The gripping assembly recited in claim 35, wherein the lumen is disposed in a collet and the channel is disposed on an outer surface of a collet housing that is configured to operatively receive the collet therein.

37. A splice assembly mechanically and electrically connecting two line segments of an overhead electrical line, the splice assembly comprising:
a first gripping assembly operatively gripping a first line segment of the overhead electrical line and a second gripping assembly operatively gripping a second line segment of the overhead electrical line, each of the first and second gripping assemblies comprising a button on an end of the gripping assembly opposite the electrical cable segment;
a spacer clip operatively joining the first gripping assembly to the second gripping assembly, the spacer clip comprising an access slot providing access to a working space within the spacer clip and comprising two button notches in a sidewall of the spacer clip, wherein the gripping assembly buttons are placed through the button notches and are secured by the spacer clip; and
a conductive sleeve body disposed over the gripping assemblies and the spacer clip, the conductive sleeve body electrically connecting a conductor of the first cable segment to a conductor of the second cable segment.

38. The splice assembly recited in claim 37, comprising a window port disposed through the conductive sleeve body.

39. The splice assembly recited in claim 38, comprising a window port cover removably covering the window port.

40. The splice assembly recited in any one of claims 37 to 39, wherein each of the first overhead electrical cable segment and the second overhead cable segment comprises at least one optical fiber associated with the overhead cable segment, wherein the optical fiber of the first segment is operatively joined to the optical fiber of the second segment within the splice assembly.
